(19) United States
(12) Patent Application Publication
(10) Pub. No.: US 2014/0337856 A1
(43) Pub. Date: Nov. 13, 2014

(54) DATA PARALLEL PROCESSING APPARATUS WITH MULTI-PROCESSOR AND METHOD THEREOF

(71) Applicant: Electronics and Telecommunications Research Institute, Daejeon (KR)

(72) Inventors: Jung Hee LEE, Daejeon (KR); Bhum Cheol LEE, Daejeon (KR); Seung Woo LEE, Daejeon (KR); Sang Min LEE, Daejeon (KR); Kang Il CHOI, Daejeon (KR); Young Ho PARK, Daejeon (KR)

(73) Assignee: Electronics and Telecommunications Research Institute, Daejeon (KR)

(21) Appl. No.: 14/038,538

(22) Filed: Sep. 26, 2013

(30) Foreign Application Priority Data
May 10, 2013 (KR) 10-2013-0053286

(51) Int. Cl. G06F 9/52

(52) U.S. Cl. CPC G06F 9/52
USPC 718/107

(57) ABSTRACT

The present invention suggests a data parallel processing device that performs parallel processing on input data by varying a flow ID generating manner depending on a loading degree of the processor in the multi-processor structure configured by processor array. The suggested device includes a flow ID generating unit which generates a flow ID for input data which is differentiated in accordance with a status of a buffer; a data allocating unit which allocates data having the same flow ID to a specified processor; and a data processing unit which sequentially processes data allocated to each processor so that the parallel processing performance is improved as compared with the related art.

### CROSS-REFERENCE TO RELATED APPLICATIONS

This application claims priority to and the benefit of Korean Patent Application No. 10-2013-0053286 filed in the Korean Intellectual Property Office on May 10, 2013, the entire contents of which are incorporated herein by reference.

### TECHNICAL FIELD

The present invention relates to an apparatus of parallel-processing data including a packet and a method thereof and more specifically, to an apparatus of parallel-processing data including a packet using a multi-processor and a method thereof.

### BACKGROUND ART

A multi-processor has advantages in data processing performance and power consumption and implements functions by mounting various programs therein so that it is expected that the usage of the multiprocessors may increase in various fields such as a terminal, home appliances, communication, and broadcasting.

According to Amdahl's law, an increased processing speed (speed up) by the multi-processor is as follows:

S=1/(1−fₚ+fₚ/N)

Here, S indicates an increased processing speed, fₚ indicates a parallel processing rate, and N indicates a number of individual processors in the multi-processor.

As known from the above-equation, the increased processing speed by the multi-processor relates with the parallel processing rate. It is understood that when the multi-processing rate is low, even though the number of individual processors which configure the multi-processor is increased, the processing speed of the multi-processor is not increased but saturated.

A multi-processor has been applied to a network processor since approximately 2000, in order to improve a packet processing speed in a network including classes 1 to 4. As understood from Amdahl's law, in order to linearly increase the parallel processing speed with respect to the number of individual processors, effect may be significant when parallel-processed parts are much more than the serial-processed parts.

A related art that suggests a structure in which a parallel processing rate is increased in accordance with the Amdahl's law to improve the parallel processing performance is disclosed in U.S. Pat. No. 6,854,117.

According to the related art, the parallel processing speed is linearly increased with respect to the number of processors based on the Amdahl's law by reducing a serial processing rate of the individual processors in the multi-processor and increasing the parallel processing rate. Specifically, an HOL (head of line) blocking is reduced so that a packing processing time is correspondingly shortened.

According to this related art, when various flow IDs are input, parallel processing performance is excellent. However, when a small number of flow IDs or data having the same flow ID is continuously input, a load is concentrated on an arbitrary process so that input data cannot be processed or loss may occur. Therefore, data processing delay time is significantly lasted.

### SUMMARY

The present invention has been made in an effort to provide a data parallel processing device which includes a processor array configured by a plurality of processors and vary a flow ID generating manner depending on a loading degree of a processor to perform the data parallel processing and a method thereof to improve a parallel processing performance.

The foregoing summary is illustrative only and is not intended to be in any way limiting. In addition to the illustrative aspects, embodiments, and features described above, further aspects, embodiments, and features will become apparent by reference to the drawings and the following detailed description.

A data parallel processing device including a multi-processor according to the exemplary embodiment may include a flow ID generating unit which generates a flow ID for input data which is differentiated in accordance with a status of a buffer; a data allocating unit which allocates data having the same flow ID to a specified processor; and a data processing unit which sequentially processes data allocated to each processor.

The flow ID generating unit may generate a flow ID in accordance with a first manner in a normal situation and generates the flow ID using a second manner in which the number of hierarchies or field information is subdivided more than the first manner when a data transfer to a specific processor through a buffer is delayed and.

The flow ID may be generated by the first manner and the flow ID generating unit generates a flow ID using information on a hierarchy selected with respect to the input packet among first to fourth classes or header information of the input packet and when the flow ID is generated by the second manner, the flow ID generating unit uses payload field information in addition to the information on a hierarchy selected with respect to the input packet among first to fourth classes or header information of the input packet.

The flow ID generating unit may use information on a class selected with respect to the input packet among fifth to seventh classes as payload field information.

The flow ID generating unit may generate the flow ID by a method determined depending on a relationship each threshold value using at least two threshold values.

When the flow ID is generated by the second manner, the data allocating unit may store the flow ID generated by the second manner in the buffer until all processors are in an idle status.

The data processing unit may process the data using forwarding information or QoS information stored in a database.

A data parallel processing method using a multi-processor, includes: generating a flow ID for input data which is differentiated in accordance with a status of a buffer; allocating data having the same flow ID to a specified processor; and sequentially processing data allocated to each processor.

The generating of a flow ID includes generating a flow ID in accordance with a first manner in a normal situation; and generating the flow ID using a second manner in which the number of hierarchies or field information is subdivided more than the first manner when a data transfer to a specific processor through a buffer is delayed.

The generating of a flow ID includes: generating a flow ID using information on a hierarchy selected with respect to the input packet among first to fourth classes or header information of the input packet and when the flow ID is generated by the second manner, generating the flow ID using in addition to the information on a hierarchy selected with respect to the input packet among first to fourth classes, the header information of the input packet, and payload field information.

The generating of a flow ID uses information on a class selected with respect to the input packet among fifth to seventh classes as payload field information.

The generating of a flow ID generates the flow ID by a method determined depending on a relationship each threshold value using at least two threshold values.

When the flow ID is generated by the second manner, the allocating of the data stores the flow ID generated by the second manner in the buffer until all processors are in an idle status.

The processing of data includes processing the data using forwarding information or QoS information stored in a database.

According to the present invention, in a multi-processor structure configured by a processor array, a generating method of a flow ID is varied depending on a loading degree of a processor to perform parallel processing on input data to increase parallel processing rate in the multi-processor and easily control power consumption by operation depending on a function and a performance.

### BRIEF DESCRIPTION OF THE DRAWINGS

FIG. 1 is a block diagram schematically illustrating a data parallel processing device according to an exemplary embodiment of the present invention.

FIG. 2 is a conceptual diagram illustrating a parallel processing structure according to an exemplary embodiment of the present invention.

FIG. 3 is a conceptual diagram illustrating one-hierarchy parallel processing operation principle by the structure of FIG. 2.

FIG. 4 is a conceptual diagram illustrating two-hierarchy parallel processing operation principle by the structure of FIG. 2.

FIG. 5 is a flowchart schematically illustrating a data parallel processing method according to an exemplary embodiment of the present invention.

In the figures, reference numbers refer to the same or equivalent parts of the present invention throughout the several figures of the drawing. The below exemplary embodiment combines the components and features in a predetermined shape.

### DETAILED DESCRIPTION

The following description illustrates only a principle of the present invention. Therefore, it is understood that those skilled in the art may implement the principle of the present invention and invent various apparatuses, which are included in a concept and a scope of the present invention, even though not clearly described or illustrated in the specification. It should be further understood that all conditional terms and exemplary embodiments which are described in the specification are intended to understand the concept of the invention but the present invention is not limited to the exemplary embodiments and states specifically described in the specification. The above objects, features, and advantages will be more obvious from the detailed description with reference to the accompanying drawings, and the technical spirit of the present invention may be easily implemented by those skilled in the art. However, in describing the present invention, if it is considered that specific description of related known configuration or function may cloud unnecessarily the gist of the present invention, the detailed description thereof will be omitted. Hereinafter, an exemplary embodiment of the present invention will be described in detail with reference to the accompanying drawings.

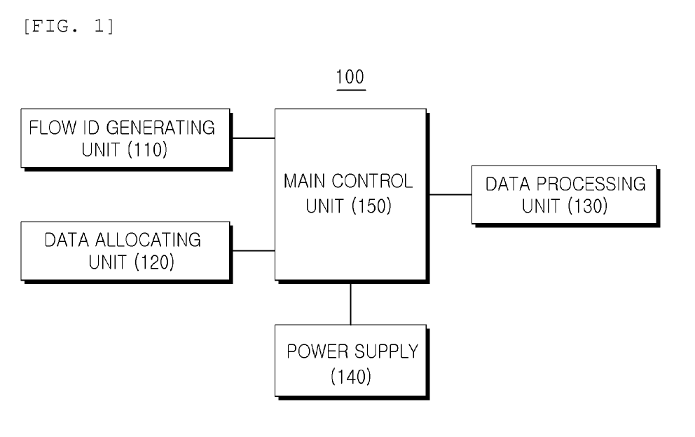

FIG. 1 is a block diagram schematically illustrating a data parallel processing device according to an exemplary embodiment of the present invention. Referring to FIG. 1, a data parallel processing device 100 according to an exemplary embodiment includes a flow ID generating unit 110, a data allocating unit 120, a data processing unit 130, a power supply 140, and a main control unit 150.

The flow ID generating unit 110 performs a function that generates a flow ID for input data which is differentiated in accordance with a status of a buffer.

Usually, the flow ID generating unit 110 generates a flow ID in accordance with a first manner. When the input data is an input packet, the flow ID generating unit 110 generates a flow ID using information on a class selected with respect to the input packet among first to fourth classes or header information of the input packet.

In contrast, when a data transfer to a specific processor through a buffer is delayed, the flow ID generating unit 110 generates the flow ID using a second manner in which the number of hierarchies or field information is subdivided more than the first manner. When the input data is an input packet, the flow ID generating unit 110 uses payload field information in addition to the information on a class selected with respect to the input packet among first to fourth classes or header information of the input packet. In this exemplary embodiment, the flow ID generating unit uses information on a class selected with respect to the input packet among fifth to seventh classes as payload field information. The functions of the flow ID generating unit 110 is provided to consider a case when the flow ID is generated using the second manner in which the number of classes is further subdivided. When the flow ID is generated using the second manner in which the number of classes is further subdivided, the flow ID generating unit 110 perform primary division using URL information (www.naver.com) and then extends dept. of a field such as www.naver.com/123 . . . / . . . if required for more subdivision.

In the meantime, the flow ID generating unit 110 generally generates the flow ID using one threshold value. However, the flow ID may be generated by a method determined depending on a relationship with each threshold value using at least two threshold values.

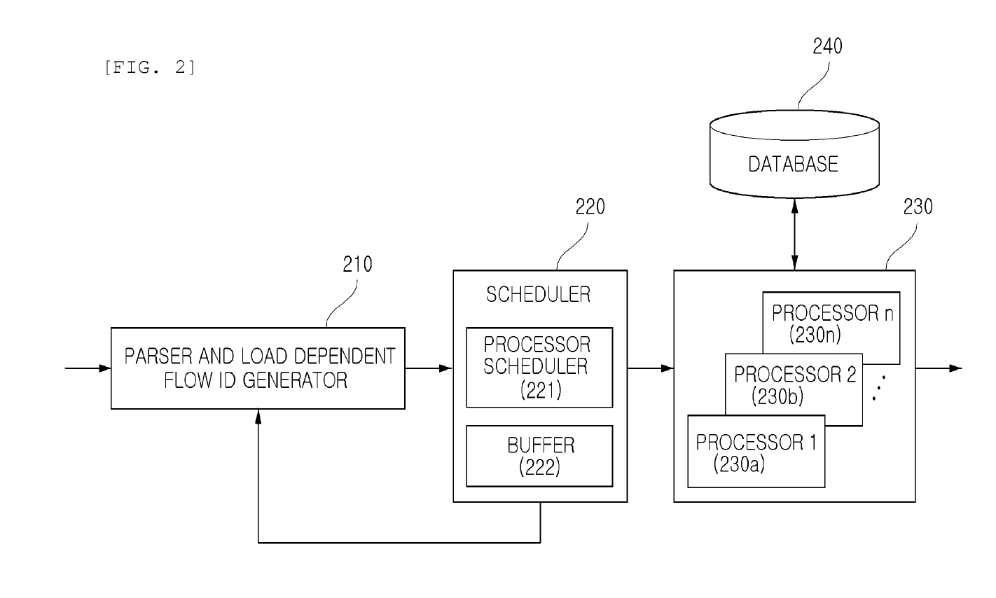

The flow ID generating unit 110 described above will be described in detail with reference to a parser and a load dependent flow ID generator of FIG. 2.

The data allocating unit 120 performs a function that allocates data having the same flow ID to a specified processor.

When the flow ID is generated by the second manner, the data allocating unit 120 stores the flow ID generated by the second manner in a buffer until all processors are in an idle state.

The data allocating unit 120 will be described in detail with reference to a scheduler of FIGS. 2 to 4.

The data processing unit 130 performs a function that sequentially processes data allocated to each processor.

The data processing unit 130 processes data using forwarding information or QoS information stored in a database.

The data processing unit 130 will be described in detail with reference to a processor array of FIGS. 2 to 4.

The power supply 140 performs a function that supplies a power to components of the data parallel processing device 100.

The main control unit 150 performs a function that controls overall operation of the components of the data parallel processing device 100.

Next, an exemplary embodiment of the present invention will be described with reference to FIGS. 2 to 4. FIG. 2 is a conceptual diagram illustrating a parallel processing structure according to an exemplary embodiment of the present invention.

The exemplary embodiment has a parallel processing structure having a processor array 230 configured by one or more processors, a scheduler 220 for the processor array, and a parser and load dependent flow ID generator 210 to generate the flow ID to be varied depending on status of a threshold value of the buffer 222 in the scheduler 220.

Hereinafter, a configuration and an operating principle of the exemplary embodiment will be described with reference to FIG. 2. Hereinafter, an input packet is illustrated as an example of input data, but the input data is not limited to the input packet in the exemplary embodiment.

The exemplary embodiment includes the parser and Load-dependent flow ID generator 210, the scheduler 220, the processor array 230 configured by a plurality of processors 230a to 230n which is capable of performing arbitrary processing, and a database 240. Here, n indicates a natural number of 1 or larger.

The parser and load dependent flow ID generator 210 generates a hash key for an input packet using a classification rule and a flow with a hash value using a hash function. In this case, the hash value is generated as two types of hierarchies depending on threshold value information of the buffer 222 which is input from the scheduler 220 as follows.

1) Hierarchy 1 flow ID: the parser and load dependent flow ID generator 210 generates a hash key in accordance with the classification rule using header information of the packet and a flow with a basic hash value using the hash function. The flow generated in this time has a hierarchy 1 flow ID. The classification rule selects from information on classes 1 to 4 of the packet.

2) Hierarchy 2 flow ID: the parser and load dependent flow ID generator 210 the scheduler 220 generates the hash key in accordance with the classification rule using the header information of a packet when the threshold value status information of the buffer 222 is received and the payload field information and generates a flow with an extension hash value using the hash function. The flow generated in this time has a hierarchy 2 flow ID. The payload field information is selected from information of classes 5 to 7 of the packet.

When the parser and load dependent flow ID generator 210 generates a flow, if the payload field information is used, the flow IDs are diversely classified for every application, every service, and every content so that parallel processing may be performed on the packet. However, when this method is used, it takes lots time to generate the flow, a processing time is delayed, and the flow management is complex so that this method is used only when the threshold value status is generated. The classification rule may be selectively varied.

In the meantime, when the flow ID is generated with more number of hierarchies, the parser and load dependent flow ID generator 210 sets the threshold value at multiple levels and information on the input data may be further subdivided.

The scheduler 220 includes a processor scheduler 221 and the buffer 222.

The processor scheduler 221 schedules the processor array 230 configured by the plurality of processors 230a to 230n and allocates the flow IDs thereto. When a previous flow with a specific ID is being processed in a processor 1 230a, the processor scheduler 221 allocates an input flow with the same ID as the specific ID to the first processor 230a and allocates an input flow with an ID which is different from the specific ID to a different processor. The processor scheduler 221 may perform the parallel processing of a packet while maintaining an order of the flow having the same property (that is, the same flow ID) through the above scheduling process.

When a specific processor (one selected from the processors 230a to 230n of the processor array 230 processes a previously input flow, the flow input from the parser and load dependent flow ID generator 210 is stored in the buffer 222. When all processors 230a to 230n of the processor array 230 complete the processing on the previously input flow, the processing on the flow stored in the buffer 222 is performed. Further, even though the flow with the same ID is performed in the current processor, if there is no processor which is in an idle state, the input flow is stored in the buffer.

Buffer threshold value generating information which is input from the scheduler 220 to the parser and load dependent flow ID generator 210 is generated when an upper threshold value for the buffer 222 is generated and the buffer threshold value generating information generated in this time is released when a lower threshold value for the buffer 222 is generated. When the same flow ID is continuously generated or a parallel processing performance is lowered due to irregular generation of the flow ID, the scheduler 220 transmits the buffer threshold value generation information to the parser and load dependent flow ID generator 210 to request for fine generation of the flow ID.

The processor array 230 processes input data for every flow ID input from the scheduler 220. In this case, the processors of the processor array 230 process the data with the assistance of the database 240.

The database 240 is mainly configured by a memory such as an RAM and stores information (for example, forwarding, or QoS) required for data processing in a multi-processor array configured by one or a plurality of processors.

Next, flow ID generation in accordance with a status of a threshold value of an exemplary embodiment will be described.

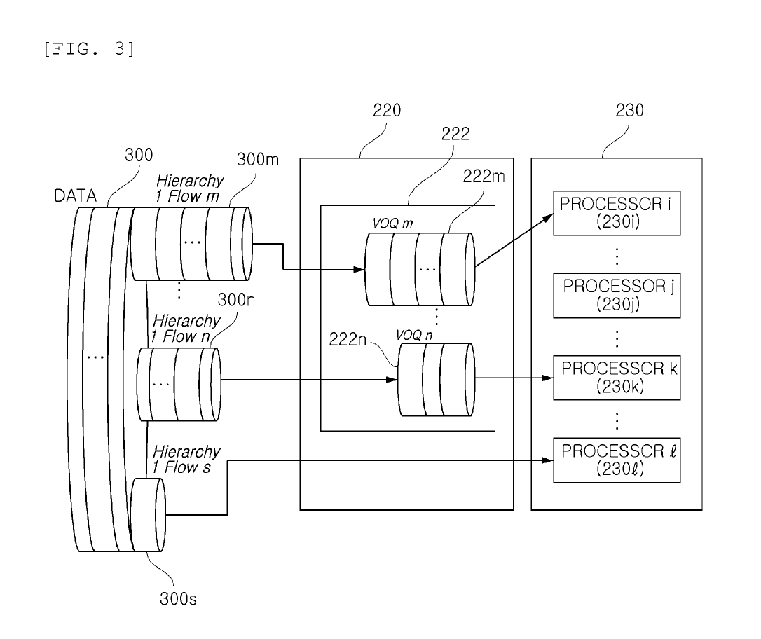

FIG. 3 is an operation diagram illustrating one-hierarchy flow ID generating and parallel processing principle before the threshold value status information is generated in the buffer 222 in the scheduler 220. The following description will be made with reference to FIG. 3.

The parser and load dependent flow ID generator 210 generates flow IDs 300m, 300n, and 300s for input data using one hierarchy information of the input data 300. Hereinafter, the parser and load dependent flow ID generator 210 transmits the generated flows 300m, 300n, and 300s to the scheduler 220. However, the processors i and k 230i and 230k process flows with the same ID which are previously input. Therefore, the scheduler 220 stores the flow with a flow ID m 300m and a flow with a flow ID n 300n in buffers 222m and 222n, respectively. In contrast, since there is no processor which processes a flow with a flow ID s 300s, the flow with a flow ID s 300s is not stored in the buffer 222 and the data is processed in one of arbitrary processors which are in an idle status. Referring to FIG. 3, the flow with the flow ID s 300s is processed in the processor l 230l. The buffer 222 is a common buffer and thus is not allocated for individual processors.

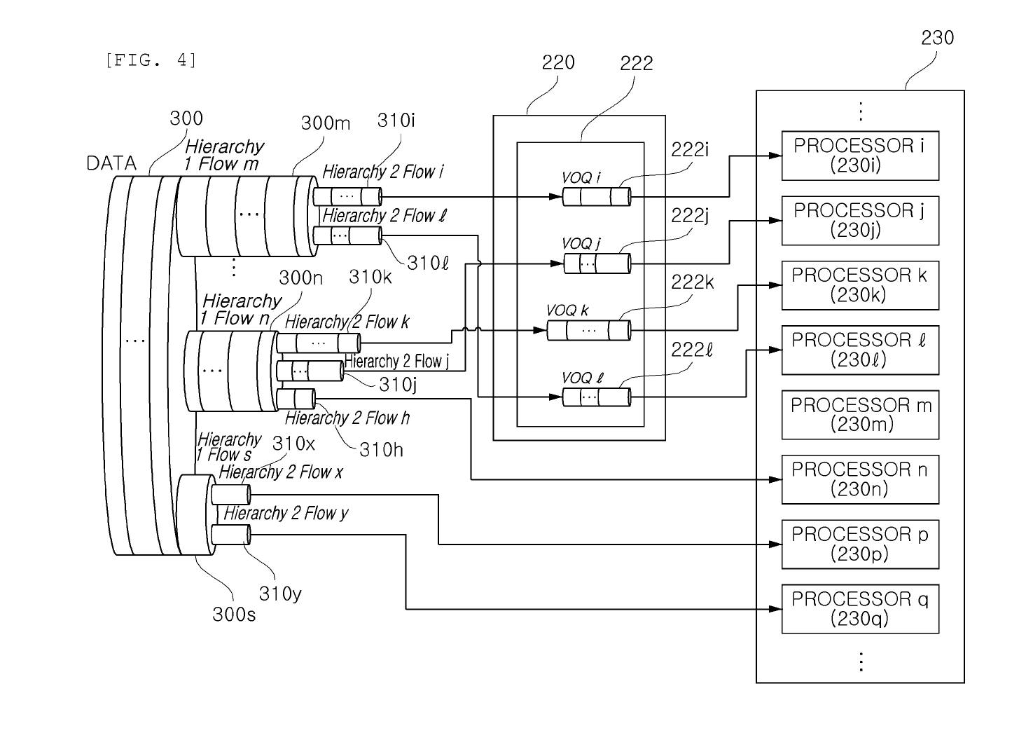

FIG. 4 is an operation diagram illustrating two-hierarchy flow ID generating and parallel processing principle after the threshold value status is generated. The following description will be made with reference to FIG. 4.

The scheduler 220 generates the buffer threshold value generation information when an upper threshold value for the buffer 222 is generated. When the buffer threshold value generation information is generated, the buffer threshold value generation information is maintained until a lower threshold value for the buffer 222 is generated.

The parser and load dependent flow ID generator 210 which receives the buffer threshold value generation information generates two-hierarchy flow ID. In this case, the parser and load dependent flow ID generator 210 divides the one-hierarchy ID into a plurality of flow IDs so as to be subdivided to generate two-hierarchy flow ID. That is, as illustrated in FIG. 4, the one-hierarchy flow ID m 300m is divided into a two-hierarchy ID i 300i and a two-hierarchy ID l 300l. By doing this, the scheduler 220 schedules the two-hierarchy ID i 300i and the two-hierarchy ID l 300l so as to be processed in the processor i 230i and the processor l 230l or stored in a VOQ i 222i and a VOQ l 222l.

A one-hierarchy flow ID n 300n is divided into a two-hierarchy ID k 310k, a two-hierarchy ID j 310j, and a two-hierarchy ID h 310h. The scheduler 220 schedules the two-hierarchy ID k 310k, and the two-hierarchy ID j 310j, and the two-hierarchy ID h 310h so as to be processed in a processor i 230i, a processor j 230j and a processor l 230l, respectively or stored in a VOQ k 222k and a VOQ j 222j, respectively. In the case of two-hierarchy flow ID h 310h, the same flow ID which is previously input is not processed in the processor so that the two-hierarchy flow ID h 310h is not stored but directly processed by the processor n 230n.

Similarly, the one-hierarchy flow ID s 300s is divided into a two-hierarchy flow ID x 310x and a two-hierarchy flow ID y 310y. The scheduler 220 schedules the two-hierarchy flow ID x 310x and the two-hierarchy flow ID y 310y so as to be processed in the processor p 230p and the processor q 230q, respectively. In the case of the two-hierarchy flow ID x 310x and the two-hierarchy flow ID y 310y, the same flow ID which is previously input is not processed in the processor so that the flow ID is not stored in the buffer 220 but is directly processed by the processor p 230p and the processor q 230q.

Characteristics of the exemplary embodiment described above will be summarized as follows:

First, the multi-processor parallel processing device according to an exemplary embodiment includes a multi-processor which is configured by arranging one or more processors in order to process data in the multi-processor in parallel, the scheduler for parallel processing of the multi-processor, and the parser and load dependent flow ID generator which improves the parallel processing performance to perform the parallel processing which is divided in accordance with a loading degree of the processor.

Second, when the buffer exceeds an upper threshold value in the scheduler for parallel processing of the multi-processor, the threshold-value generation information is transmitted to the parser and load dependent flow ID generator. Further, when the buffer status is changed from the upper threshold value status into the lower threshold value status, the threshold value release information is transmitted to the parser and load dependent flow ID generator.

Third, information on a class of the input data is selected in accordance with the buffer threshold value status information which is input from the scheduler in the parser and load dependent flow ID generator for improving the parallel processing performance to generate the flow ID so that the flow ID is generated with minimum basic hierarchy information before generating the threshold value and the flow ID is generated by selectively extending hierarchy information when the threshold value is generated to improve the parallel processing performance.

Fourth, the threshold value information is generated to be expanded at multiple levels.

Fifth, the parser and load dependent flow ID generator receives multi-level threshold value information to flow IDs with multiple hierarchies.

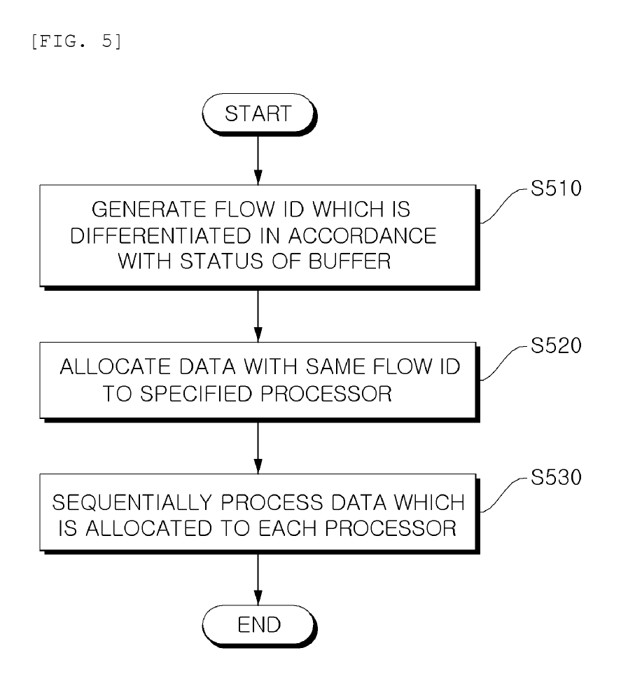

Next, a data parallel processing method of the data parallel processing device 100 will be described. FIG. 5 is a flowchart schematically illustrating a data parallel processing method according to an exemplary embodiment of the present invention.

First, in step S510, the flow ID generating unit 110 generates a flow ID which is differentiated in accordance with a status of a buffer.

The flow ID generating unit 110 generates the flow ID by a first manner in step S510. When an input packet is used as input data, the flow ID generating unit 110 generates the flow ID using information on a class selected with respect to the input packet among first to fourth classes and header information.

When the data transfer to a specific processor through the buffer is delayed, the flow ID generating unit 110 generates the flow ID by a second manner in which the number of hierarchies or field information is subdivided more than the first manner in step S510. When an input packet is used as input data, the flow ID generating unit 110 generates the flow ID using payload field information in addition to the information on a class selected with respect to the input packet among first to fourth classes and the header information.

In the meantime, the flow ID generating unit 110 may generate the flow ID by a method determined depending on a relationship with each threshold value using at least two threshold values.

After step S510, in step S520, the data allocating unit 120 allocates data having the same flow ID to a specified processor. When the flow ID is generated by the second manner in step S510, the data allocating unit 120 stores the flow ID generated by the second manner in a buffer until all processors are in an idle state.

After step S520, in step S530, the data processing unit 130 sequentially processes data allocated to each processor. In this case, the data processing unit 130 processes data using forwarding information or QoS information stored in a database.

Even though all components of the exemplary embodiment are combined as one component or combined to be operated, the present invention is not limited to the exemplary embodiment. In other words, one or more of all components may be selectively combined to be operated without departing from the spirit or scope of the present invention.

Further, all components may be implemented as one independent hardware but a part or all of the components are selectively combined to be implemented as a computer program which includes a program module which performs a part or all of functions combined in one or plural hardwares. Further, such a computer program may be stored in a computer readable media such as a USB memory, a CD disk, or a flash memory to be read and executed by a computer to implement the exemplary embodiment of the present invention. The recording media of the computer program may include a magnetic recording medium, an optical recording medium, or a carrier wave medium.

If it is not contrarily defined in the detailed description, all terms used herein including technological or scientific terms have the same meaning as those generally understood by a person with ordinary skill in the art. A generally used terminology which is defined in a dictionary may be interpreted to be equal to a contextual meaning of the related technology but is not interpreted to have an ideal or excessively formal meaning, if it is not apparently defined in the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A data parallel processing device including a multi-processor, comprising:
a flow ID generating unit which generates a flow ID for input data which is differentiated in accordance with a status of a buffer;
a data allocating unit which allocates data having the same flow ID to a specified processor; and
a data processing unit which sequentially processes data allocated to each processor.

2. The data parallel processing device of claim 1, wherein the flow ID generating unit generates a flow ID in accordance with a first manner in a normal situation and generates the flow ID using a second manner in which the number of hierarchies or field information is subdivided more than the first manner when a data transfer to a specific processor through a buffer is delayed.

3. The data parallel processing device of claim 2, wherein the flow ID is generated by the first manner, the flow ID generating unit generates a flow ID using information on a hierarchy selected with respect to the input packet among first to fourth classes or header information of the input packet and if the flow ID is generated by the second manner, the flow ID generating unit uses payload field information in addition to the information on a hierarchy selected with respect to the input packet among first to fourth classes or header information of the input packet.

4. The data parallel processing device of claim 3, wherein the uses information on a class selected with respect to the input packet among fifth to seventh classes as payload field information.

5. The data parallel processing device of claim 1, wherein the flow ID generating unit generates the flow ID by a method determined depending on a relationship each threshold value using at least two threshold values.

6. The data parallel processing device of claim 2, wherein when the flow ID is generated by the second manner, the data allocating unit stores the flow ID generated by the second manner in the buffer until all processors are in an idle status.

7. The data parallel processing device of claim 1, wherein the data processing unit processes the data using forwarding information or QoS information stored in a database.

8. A data parallel processing method using a multi-processor, comprising:
generating a flow ID for input data which is differentiated in accordance with a status of a buffer;
allocating data having the same flow ID to a specified processor; and
sequentially processing data allocated to each processor.

9. The data parallel processing method of claim 8, wherein the generating of a flow ID includes:
generating a flow ID in accordance with a first manner in a normal situation; and
generating the flow ID using a second manner in which the number of hierarchies or field information is subdivided more than the first manner when a data transfer to a specific processor through a buffer is delayed.

10. The data parallel processing method of claim 9, wherein the generating of a flow ID includes:
generating a flow ID using information on a hierarchy selected with respect to the input packet among first to fourth classes or header information of the input packet and
when the flow ID is generated by the second manner, generating the flow ID using in addition to the information on a hierarchy selected with respect to the input packet among first to fourth classes, the header information of the input packet, and payload field information.

11. The data parallel processing method of claim 10, wherein the generating of a flow ID uses information on a class selected with respect to the input packet among fifth to seventh classes as payload field information.

12. The data parallel processing method of claim 8, wherein the generating of a flow ID generates the flow ID by a method determined depending on a relationship each threshold value using at least two threshold values.

13. The data parallel processing method of claim 9, wherein when the flow ID is generated by the second manner, the allocating of the data stores the flow ID generated by the second manner in the buffer until all processors are in an idle status.

14. The data parallel processing method of claim 8, wherein the processing of data includes processing the data using forwarding information or QoS information stored in a database.
